(19) United States
(12) Patent Application Publication
(10) Pub. No.: US 2009/0120698 A1
(43) Pub. Date: May 14, 2009

(54) Harrison automobiles (HA) that use the kinetic energy stored in Harrison flywheel engines (HFE) to power and control automobiles and other machines

(76) Inventor: Wilbur Ernest Harrison, JR., Melbourne, FL (US)

Correspondence Address: Wilbur E. Harrison, Jr., 1581 Perdido Court, Melbourne, FL, 32940-6226, US

(21) Appl. No.: 11/397,867

(22) Filed: Apr. 5, 2006

(51) Int. Cl. B60K 6/10; B60L 9/00; B60L 7/10

(52) U.S. Cl. 180/2.1; 180/65.31; 188/159

(57) ABSTRACT

Harrison Automobiles (HA) that use the kinetic energy stored in Harrison Flywheel Engines (HFE), and electricity generated by Harrison Flywheel Engines (HE) to power the propulsion and control of automobiles and other machines. Propulsion and control by Harrison Flywheel Engines (HFE) shall also be used for the propulsion of other machines such as trucks, tractors, aircraft, boats, torpedoes, etc. Harrison Flywheel Engines (HFE) are fully flywheel powered, with periodic recharging required by electricity only. No gasoline is required for propulsion, operation or recharging of the Harrison Flywheel Engines (HFE). The typical flywheel powered Engine consists of two or more equal but counter rotating flywheel power units, thus neutralizing the gyroscopic moment caused by each rotating flywheel power unit. All of the flywheel power units are securely connected to a single frame, thereby storing huge amounts of kinetic energy and power, but with negligible or no gyroscopic moment that might interfere with steering of the automobile, or other machines, or full control of the Harrison Flywheel Engines (HFE) engines. Each flywheel power unit of the engine is enclosed in a hermetically sealed container, in a vacuum and is spinning in magnetic bearings, both thrust magnetic bearings and radial magnetic bearings, to prevent metal-to-metal bearing contact which causes unwanted friction, heat and loss of engine power and range to the flywheels. Therefore, these measures positively and drastically increase the maintenance free life, the performance and the effective operating range of the automobiles or other machines powered by Harrison Flywheel Engines (HFE).

### BACKGROUND OF THE INVENTION

1. Field of the Invention

The present invention relates to Harrison Automobiles (HA) that use kinetic energy stored in Harrison Flywheel Engines (HFE) and electricity generated by Harrison Flywheel Engines for automobile propulsion and control. Harrison Flywheel Engines (HFE) shall also be used for the propulsion of other machines such as trucks, tractors, aircraft, boats, torpedoes, etc. Harrison Flywheel Engines (HFE) are fully Flywheel powered; with periodic recharging required by electricity only. No gasoline is required for propulsion, operation or recharging of the Harrison Flywheel Engines (HFE). The Typical Flywheel powered Engine consists of two or more equal but counter rotating flywheel power units, thus neutralizing the gyroscopic moment caused by each rotating flywheel power unit. All of the flywheel power units are securely connected to a single frame, thereby having the kinetic energy to generate huge amounts of electric power, but with negligible or no gyroscopic moment that might interfere with steering of the automobile, or other machines, or full control of the Harrison Flywheel Engines (HFE) engines. Each flywheel power unit in the engine is enclosed in a hermetically sealed container, in a vacuum, and each is spinning in magnetic bearings, both thrust magnetic bearings and radial magnetic bearings, to prevent meta-to-metal bearing contact which causes unwanted friction, heat and loss of engine power and range to the flywheels. Therefore, these measures positively and drastically increase the maintenance free life, the performance and the effective operating range of the automobiles or other machines powered by Harrison Flywheel Engines (HFE). Flywheels are similar to gyroscopes, generating a significant gyroscopic moment; but whereas the weight of the rotor of a gyroscope is concentrated at the rotor perimeter to increase the gyroscopic moment, the weight of the flywheel rotor is concentrated at the center of the rotor, not the perimeter of the rotor. This causes the flywheel to be primarily a kinetic energy storage device. Thus, a heavy flywheel device that is spinning at a very high rate of speed, say 15,000 rpm and higher, depending upon the material composition of the rotor, has the capability to store a huge amount of kinetic energy. This kinetic energy may be used to generate power and control of an automobile, as well as other machines.

2. Description of the Prior Art

Patent application Control Ser. No. 10/065,872 Filed: Nov. 26, 2002 (Patent Pending), submitted by this inventor, consists of the use of large heavy (10,000 pounds, and higher) gyroscopes-stabilized free standing structural radar and communications high towers that support and contain radar antennas, radar equipment, communications equipment, electronic coordination systems, electric power generating equipment and multiple defense measures and equipment needed to defend the USA, USA deployed armed forces and USA Allies against hostile terrorist or other enemy incursions by manned aircraft or unmanned aircraft, cruise missiles, ICBMs and other types of illegal border violations. The current invention provides a near perfect long range defense against such threats. The current invention also provides the lowest cost option for positioning defensive systems where look down surveillance, look over-the-natural-horizon surveillance, look-up surveillance and high electric power requirements are a major consideration and a military requirement.

Patent application CIP Control Ser. No. 10/939,297 Filed: Sep. 13, 2004 (Patent Pending), submitted by this inventor, consists of the use of large heavy (10,000 to 24,000 pound and higher) gyroscopes-stabilized free standing structural radar and communications high towers that support and contain radar antennas, radar equipment, communications equipment, electronic coordination systems, electric power generating equipment and multiple defense measures and equipment needed to defend the USA, USA deployed armed forces and USA Allies against hostile terrorist or other enemy incursions by manned aircraft or unmanned aircraft, cruise missiles, ICBMs and other types of illegal border violations. The present invention provides a near perfect long range defense against such threats. The current invention also provides the lowest cost option for positioning defensive systems where look down surveillance, look over-the-natural-horizon surveillance, look-up surveillance and high electric power requirements are a major consideration and a military requirement.

### SUMMARY OF THE INVENTION

Accordingly, the current invention, which shall be described subsequently in greater detail, is offered. To attain the above objectives, representative embodiments of the concepts of the current invention are illustrated in the drawings FIG. 1, FIG. 2 and FIG. 3.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic view of the Harrison Flywheel Engine (HFE) the current invention, according to the first embodiment of the current invention.

FIG. 2 are views of the anticipated effect on the designs of automobiles using the current invention.

FIG. 3 is a perspective view illustrating a basic gyroscope, which is similar to a basic flywheel. Flywheels and gyroscopes share the working components shown above.

### DESCRIPTION OF THE PREFERRED EMBODIMENT

With reference now to the drawings, the following will be described:

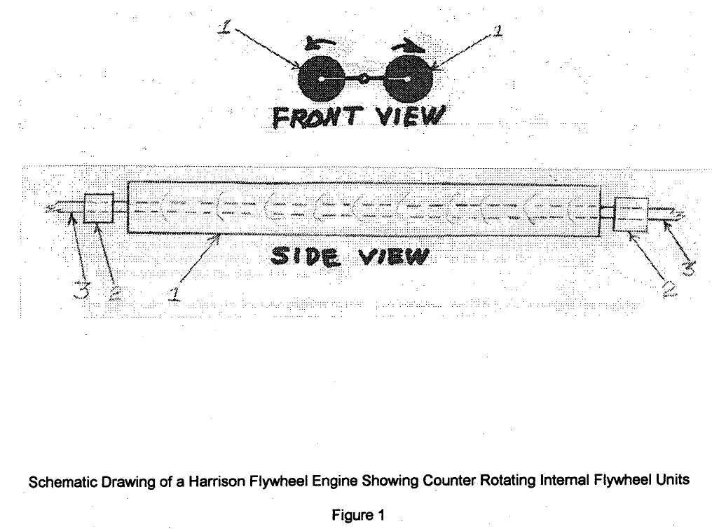

FIG. 1: More specifically, it will be noted that the first embodiment of FIG. 1 includes a schematic drawing of Harrison Flywheel Engines (HFE). 1 shows the basic rotor arrangement of a Harrison Flywheel Engine (HFE). 2 depicts the magnetic radial bearings. 3 denotes the metal shaft (usually steel or some other magnetic material) of the rotor.

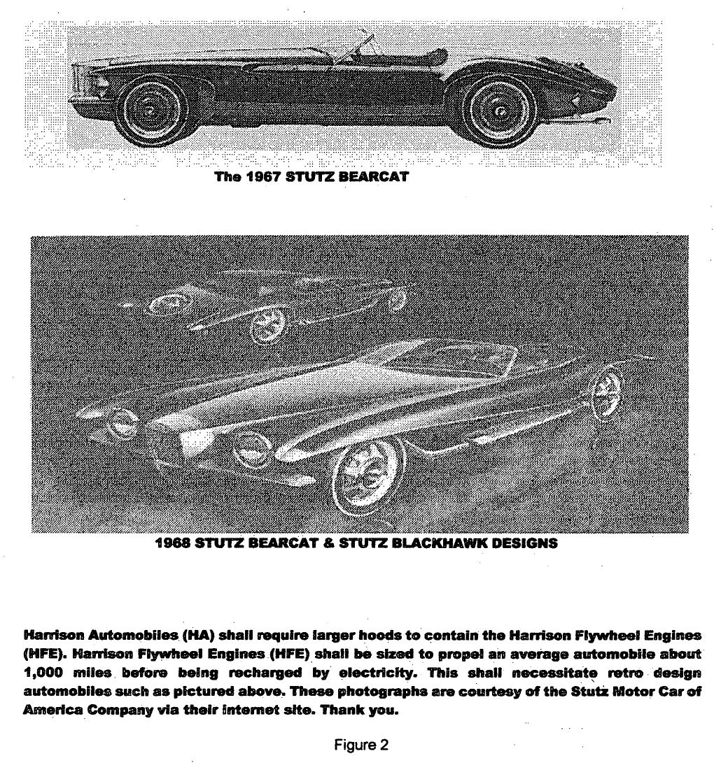

FIG. 2: denotes representative retro automobile designs considered to be representative of designs with the larger hoods required to accommodate the Harrison Flywheel Engines (HFE), which are anticipated to be longer and larger than engines in use today.

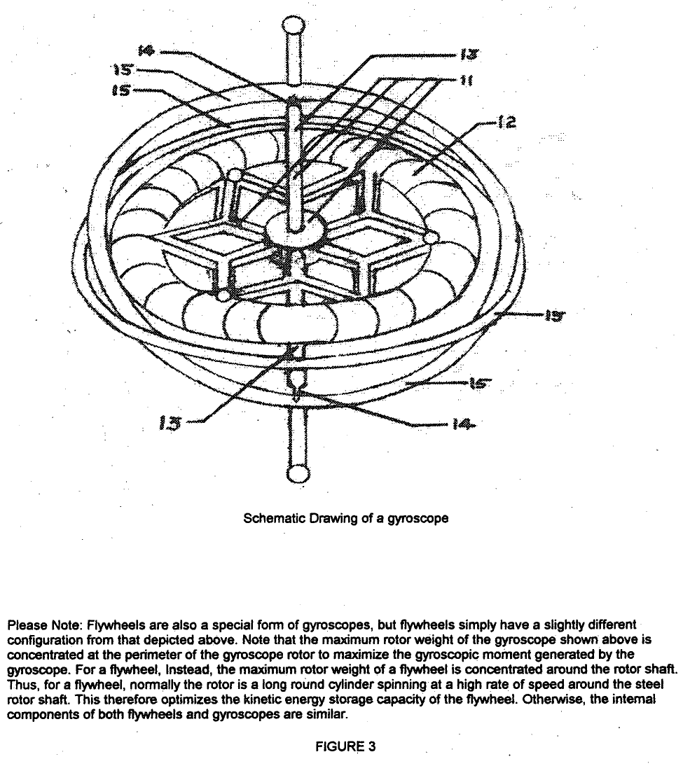

FIG. 3: is a perspective drawing of a basic gyroscope, and the normal components of a gyroscope. 11 depicts the gyroscope rotor which is the main gyroscope component that spins in the gyroscope frame. 12 is the perimeter of the gyroscope rotor where the rotor weight is concentrated; this is the main gyroscope component that spins in the gyroscope frame at a high rate of speed and produces the desired gyroscopic moment. 13 shows the gyroscope metal rotor shaft. 14 depicts the gyroscope rotor shaft thrust bearing which in this drawing is a standard metal-to-metal thrust bearing. 15 denotes the gyroscope frame. The tensile strength of the rotor materials, and other factors, govern and limit the rotor speed of rotation. The rotor shaft 13 is normally metal to maximize rotor spin life via the rotor bearings 14. Also, in practice, magnetic thrust bearings and magnetic radial bearings shall be used.

### SPECIFICATION

Harrison Automobiles (HA) that use the kinetic energy stored in Harrison Flywheel Engines (HFE) and the electricity generated by Harrison Flywheel Engines (HFE) to power the propulsion and control of automobiles and other machines. Propulsion and control by Harrison Flywheel Engines (HFE) shall also be used for the propulsion of other machines such as trucks, tractors, aircraft, boats, torpedoes, etc. Harrison Flywheel Engines (HFE) are fully Flywheel powered, with periodic recharging required by electricity only. No gasoline is required for propulsion, operation or recharging of the Harrison Flywheel Engines (HFE). The typical flywheel powered Engine consists of two or more equal but counter rotating flywheel power units, thus neutralizing the gyroscopic moment caused by each rotating flywheel power unit. All of the flywheel power units are securely connected to a single frame, thereby storing huge amounts of kinetic energy and power, but with negligible or no gyroscopic moment that might interfere with steering of the automobile, or other machines, or full control of the Harrison Flywheel Engines (HFE) engines. Each flywheel power unit of the engine is enclosed in a hermetically sealed container, in a vacuum, and is spinning in magnetic bearings, both thrust magnetic bearings and radial magnetic bearings, to prevent metal-to-metal bearing contact which causes unwanted friction, heat and loss of engine power and range to the flywheels. Therefore, these measures positively and drastically increase the maintenance free life, the performance and the effective operating range of the automobiles or other machines powered by Harrison Flywheel Engines (HFE). The design techniques include the following:

1. The use of very large and heavy (1,000 pounds to 5,000 pounds and heavier) flywheel engines, Harrison Flywheel Engines (HFE) to provide stored kinetic electric energy, converted to electric energy by generators powered by the flywheel, for the locomotion power, control and accessories operation of automobiles, as well as for other machines such as trucks, boats, aircraft, torpedoes, lawn mowers, portable electric drills and all other devices that require motors. The kinetic energy is converted into electricity by electric generators powered by (turned by) the Harrison Flywheel Engines (HFE). The gyroscopic moment produced by the multiple (2 or more) flywheel internal power units is cancelled out by the use of counter rotating internal flywheel power units.

2. Each flywheel power unit of the engine is enclosed in a hermetically sealed container, in a vacuum, and is spinning in magnetic bearings, both thrust magnetic bearings and radial magnetic bearings, to prevent metal-to-metal bearing contact. This causes unwanted friction, heat, as well as loss of engine power and range to the flywheels. Therefore, these measures positively and drastically increase the maintenance free life, the performance and the effective operating range of the automobiles or other machines powered by Harrison Flywheel Engines (HFE).

3. The use of hermetically sealed, preferably air evacuated traction electric motors shall power all wheels in Harrison Automobiles (HA) and other machines that use Harrison Flywheel Engines (HFE).

4. Brakes on each of the wheels of Harrison Automobiles (HA) shall be operated electronically and by means of electric switches that reverse the polarity of the electric traction drive motors and provide the level of braking power as needed by the use of foot operated braking rheostats actuated by the conventional brake pedal.

5. Air Conditioning, lights and other accessories shall function by electricity generated by the same generators, powered by the Harrison Flywheel Engines (HFE) that supply electric power for the propulsion traction motors.

1. The use of very large and heavy (1,000 pounds to 5,000 pounds and heavier) flywheel engines, Harrison Flywheel Engines (HFE) to provide stored kinetic energy, converted to electric energy by generators powered by the flywheel, for the locomotion electric power, electrical control and accessories operation of automobiles, as well as for other machines such as trucks, boats, aircraft, torpedoes, lawn mowers, portable electric drills and all other devices that require motors. The kinetic energy is converted into electricity by electric generators powered by (turned by) the Harrison Flywheel Engines (HFE). The gyroscopic moment produced by the multiple (2 or more) flywheel internal power units is cancelled out by the use of counter rotating internal flywheel power units. Harrison Flywheel Engines (HFE) require periodic recharging by electricity only.

2. Each flywheel power unit of the engine is enclosed in a hermetically sealed container, in a vacuum, and is spinning in magnetic bearings, both thrust magnetic bearings and radial magnetic bearings, to prevent metal-to-metal bearing contact. This causes unwanted friction, heat, as well as loss of engine power and range to the flywheels. Therefore, these measures positively and drastically increase the maintenance free life, the performance and the effective operating range of the automobiles or other machines powered by Harrison Flywheel Engines (HFE).

3. The use of hermetically sealed, preferably air evacuated traction electric motors shall power all wheels in Harrison Automobiles (HA) and other machines that use Harrison Flywheel Engines (HFE).

4. Brakes on each of the wheels of Harrison Automobiles (HA) shall be operated electronically and by means of electric switches that reverse the polarity of the electric traction drive motors and provide the level of braking power as needed by the use of foot operated braking rheostats actuated by and controlled by the conventional brake pedal.

5. Air Conditioning, lights and other accessories shall function by electricity generated by the same generators, powered by the Harrison Flywheel Engines (HFE) that supply electric power for the propulsion traction motors.
